(19) United States
(12) Patent Application Publication
(10) Pub. No.: US 2005/0040749 A1
(43) Pub. Date: Feb. 24, 2005

(54) Spark plug

(76) Inventor: Maurice E. Lindsay, El Segundo, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/645,271

(22) Filed: Aug. 20, 2003

(51) Int. Cl. H01T 13/20

(52) U.S. Cl. 313/143

(57) ABSTRACT

A spark plug includes an elongated tubular housing with a central longitudinal axis and a terminal at one end and a base having an inner side wall opposite the terminal. A portion of the internal side wall is platinum-plated. An inner chamber is formed within the housing in which is mounted an insulator. At least a portion of the insulator extends from the base and tapers to a core nose. An electrode is embedded within the insulator, a tip of which protrudes from the insulator. Ground prongs extend from the base towards the central longitudinal axis of the housing to an end. The ground prongs may have sharp edges for increased spark presentation. A ground ring may be connected to the base, from which the ground prongs extend. Electrical resistance of the spark plug is selected so that the generated spark will travel from the center electrode to the surface of the insulator and through an air gap to an end of a ground prong.

### BACKGROUND OF THE INVENTION

The present invention relates to spark plugs. More particularly, the present invention relates to a spark plug for an internal combustion engine which utilizes a surface and air gap spark path for anti-fouling and improved performance in operating efficiency while requiring less energy for spark generation.

Spark plugs are used in most internal combustion engines to provide high voltage sparks which ignite an air and fuel mixture within combustion chambers of an engine. During operation, a spark generating system delivers a pulse of electrical energy in the form of a high voltage to the terminal of the spark plug at timed intervals which are intended to coincide with combustion chamber piston placement. The spark plug directs the high voltage energy to jump or spark between a center electrode and a ground electrode of the spark plug. As the spark travels across the air gap of the center and ground electrodes, the compressed air/fuel mixture in the combustion chamber ignites, forcing the piston downward. This repeated cycle in the one or more combustion chambers, or cylinders, powers the engine.

For optimum performance the temperature of the core nose at the firing end of the spark plug should not drop below approximately 400 ° C. nor exceed approximately 850° C. Below 400° C., deposits of carbon and oil accumulate more rapidly on the core nose. As carbon is electrically conductive, a short circuit path can be created for the high voltage pulse which acts to weaken or even eliminate the spark. This is referred to as spark plug fouling which causes incomplete burning of the air/fuel mixture, possibly to a point of non-ignition. The core nose may begin to glow above 850 ° C., potentially causing the spark plug core nose to self-destruct by explosion. Aside from the loss of the spark plug, other internal components of the engine can also be severely damaged by a glowing spark plug.

A lot of effort in the past has been devoted to design spark plugs which operate within safe temperatures without accumulating carbon deposits. Most spark plugs in use today utilize a single ground prong positioned over the central electrode, in effect presenting a single spark presentation. The single spark presentation causes the spark to occur at approximately the same location each time the spark plug is operated. Any accumulations of oil or carbon not located directly in the path of spark firing, such as those deposits on the insulator surface, will remain adhered and adversely affect the use of the spark plug.

Much effort has also been devoted to designing spark plugs which produce a “hot” enough spark to quickly and as completely as possible burn the air/fuel mixture within the combustion chamber to produce more power and increase fuel efficiency. “Hotter” spark plugs also produce less pollutants which has become increasingly important in view of the many state environmental protection laws regarding automobiles.

Surface to air gap spark plugs have been provided by the Inventor in the past, such as the spark plug of U.S. Pat. No. 5,633,557 (which is hereby incorporated by reference), in order to prevent fouling while providing increased fuel efficiency and power. However, the ignition systems of newer vehicles produce less energy than earlier systems and it has been found that the design of the surface to air gap spark plug of the '557 patent rarely operates very well in these newer systems. The newer ignition systems produce adequate voltage, but use decreased amperage which provides the heat for ignition.

Some of these newer ignition systems are known as Distributorless Ignition Systems (D.I.S.) by manufacturers and “wasted spark” systems by technicians. In a four-cycle combustion engine having multiple combustion chambers, two pistons arrive at top dead center at the same time. One of the pistons is on a compression stroke wherein the air/fuel mixture is compressed and ignited by the spark, while the other piston is on an exhaust eliminating stroke. In a conventional system, full power is applied to ignite only the compression stroke chamber. In D.I.S. systems, the ignition coil is double-ended in that it has both negative and positive output terminals which are connected to both piston chamber spark plugs. Therefore, the spark plugs of both chambers fire resulting in the compression stroke chamber being ignited and the waste of a spark on the exhaust stroke chamber. The typical ignition system runs with approximately 7.5 to 8.5 amperes and 12 volts to produce 900 to 1010 watts per spark. This wattage is shared in the D.I.S. system, so that only one-half the energy is provided each spark plug. The energy requirements of the spark plug of the '557 patent have been found to be too great to run on such systems.

Accordingly, there is a need for a spark plug which self-cleans by ionizing accumulations of carbon and oil on the core nose. There is also a need for a spark plug which is more fuel efficient and creates more power while demanding less energy than prior spark plugs. The present invention fulfills these needs and provides other related advantages.

### SUMMARY OF THE INVENTION

The present invention resides in a spark plug which produces greater horsepower than prior spark plugs while decreasing fuel consumption. The spark plug also prevents fouling, or the build-up of carbon and oil deposits on the core nose of the spark plug. The novel spark plug of the present invention is designed to achieve these objectives while operating in more modern cars which supply the spark plugs with a limited amount of electrical energy.

The improved spark plug is constructed similar to conventional spark plugs in that it has an elongated tubular housing having a central longitudinal axis. The housing has a terminal at one end to which the electrical supply from the vehicle is attached, and a base having an inner side wall opposite the terminal. At least a portion of the inner side wall is platinum-plated. An inner chamber is formed within the housing in which is mounted an insulator. At least a portion of the insulator extends from the base and tapers to a core nose. An electrode is embedded within the insulator, a tip of which protrudes from the insulator.

In contrast to conventional spark plugs, at least one ground prong extends from the base towards the central longitudinal axis of the housing to an end. The ground prong may have sharp edges for increased spark presentation. Preferably, multiple ground prongs extend from the base. A ground ring may be connected to the base, from which the ground prong or multiple ground prongs would extend.

A terminal end of the insulator can be aligned with the ends of the ground prongs, extend past the ends of the ground prongs, or the ground prongs may extend past the insulator as the requirements for the particular engine dictate. Typically, the insulator tapers to a core nose and is generally frustroconical in shape.

A relatively unique result of the placement, spacing and material properties of the base, insulator, central electrode, and ground prongs is that instead of the spark jumping from the central electrode directly to the ground prong, the spark instead selects the path of least electrical resistance from the central electrode to the insulator and then crosses an air gap between the insulator and the ground prong end. This phenomenon is described as surface and air gap spark travel. The result of this phenomenon with the placement of one or more ground prongs about the insulator allows the spark to ionize any accumulation of carbon and oil surface deposits on the insulator while allowing multiple spark presentations. Another result of the design of the spark plug is that the energy requirements for the spark plug do not increase linearly with increased combustion chamber pressures as in conventional spark plugs.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is an elevational view of a spark plug embodying the present invention;

FIG. 2 is a bottom plan view of the spark plug of FIG. 1;

FIG. 3 is a fragmented cross-sectional view of the spark plug taken generally along line 3-3 of FIG. 2, wherein the ground prongs are aligned with an end of an insulator;

FIG. 4 is a fragmented cross-sectional view similar to FIG. 3, illustrating the insulator having a shortened core nose and extending beyond the ground prongs;

FIG. 5 is a bottom plan view of a spark plug embodying the present invention, having saw-tooth ended ground prongs;

FIG. 6 is a bottom plan view of a spark plug embodying the present invention, having irregular shaped ground prongs;

FIG. 7 is a fragmented cross-sectional view of another spark plug embodying the present invention, wherein the ground prongs extend over the insulator; and

FIG. 8 is a bottom plan view of the spark plug of FIG. 7.

### DETAILED DESCRIPTION OF THE PREFERRED EMBODIMENTS

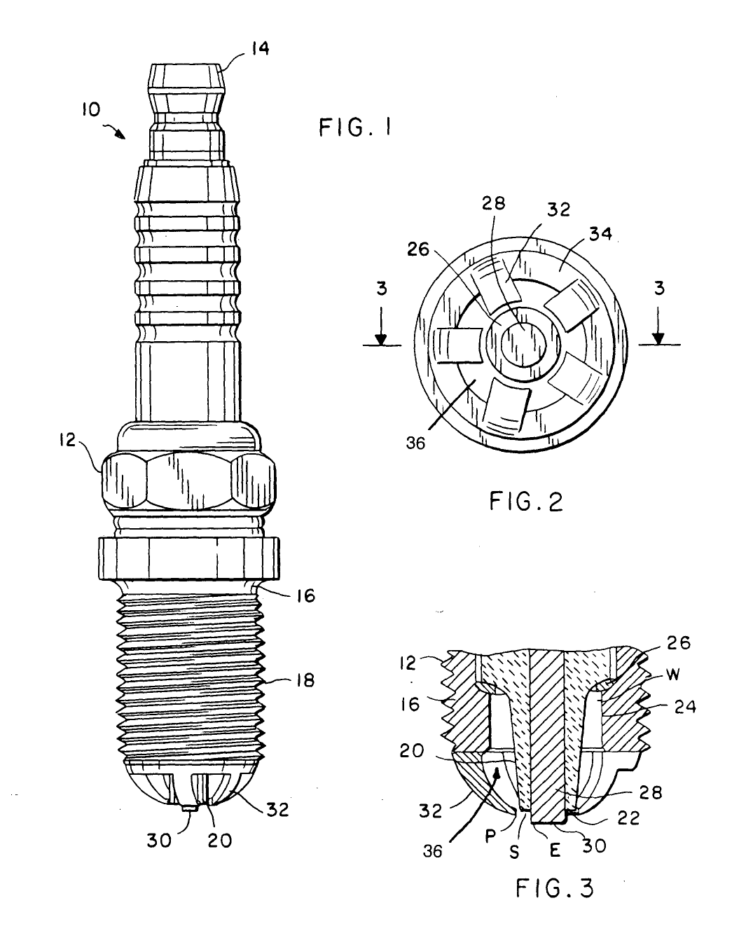

As shown in the drawings for purposes of illustration, the present invention is concerned with a spark plug, generally referred to in the drawings by the reference number 10. As illustrated in FIGS. 1-3, the spark plug 10 has an outer elongated tubular housing 12 having an upper end which is formed into a terminal 14. This terminal 12 is electrically connected to the ignition system of the engine which supplies the electrical energy to power or fire the spark plug 10. At the opposite end of the spark plug 10 is formed a base 16. A portion of the exterior surface of the housing 12, typically adjacent the base 16, includes a series of screw threads 18. The purpose of the screw threads 18 is to facilitate mounting the spark plug 10 within a receiving hole of an engine which accesses a combustion chamber.

Mounted within the tubular housing 12 is an insulator 20. The insulator 20 typically comprises a non-conductive and heat resistant material. The insulator 20 extends from the base 16 of the housing 12, and generally tapers to form a frustroconical shape, although the insulator 20 is not limited by this shape. The bottom end of the insulator 20 is formed into a core nose 22. Although the core nose 22 can be planar, as shown in FIG. 3, it is also not limited to this structure. Furthermore, the core nose 22 as defined is not limited to the lowermost portion of the insulator 20, but may include a larger exterior portion of the insulator 20 as function and design of the spark plug 10 dictates. As the insulator 20 exits the base 16 and tapers away from the base 16, an inner side wall 24 of the base 16 is exposed. A gas-tight seal 26 is located between the insulator 20 and the housing 12. Use of such seals are conventional in spark plugs.

The terminal 14 is electrically connected to a center electrode 28 which is embedded within the insulator 20 and generally runs along the longitudinal axis of the spark plug housing 12. The center electrode 28 generally has the same transverse cylindrical cross-section throughout its entire longitudinal length. The center electrode 28 exits the core nose 22 end of the insulator 20 to form a tip 30. The tip 30 is where the spark is generated, known as the firing end of the spark plug 10. The tip 30 is generally of the same cross-section as the center electrode 28, although it can be formed into a cone. The center electrode can be comprised of any conductive material, with precious metals such as gold, palladium platinum etc. being used to extend the useful life in conventional spark plugs.

Ground prongs 32 extend from the generally planar end of the base 16 and towards the core nose 22 and center electrode 28. Although the spark plug 10 is illustrated as having five ground prongs 32, there can be as few as a single ground prong 32 or any number of multiples. Preferably, multiple ground prongs 32 are used so that the generated spark has multiple spark presentations or grounding travel paths to select from. Although the ground prongs 32 may extend directly from the base 16 itself, preferably a ground ring 34 is formed from or otherwise attached to the base 16 from which the ground prongs 32 extend. The ground prong 32 and ground ring 34 may be constructed of a variety of conductive materials such as platinum, gold, steel stainless, ceramics, etc.

The ground prongs 32 extend to an end closest to the core nose 22 and center electrode 28, referred to within this description as P. As illustrated in FIGS. 5 and 6, the ground prong end P can be configured in a number of shapes. Such ends can include round, oval, square, irregular, etc., however, it is preferable that the end P have sharp edges to facilitate the grounding of the spark as sparks seek sharp edges or points over rounded and flat edges.

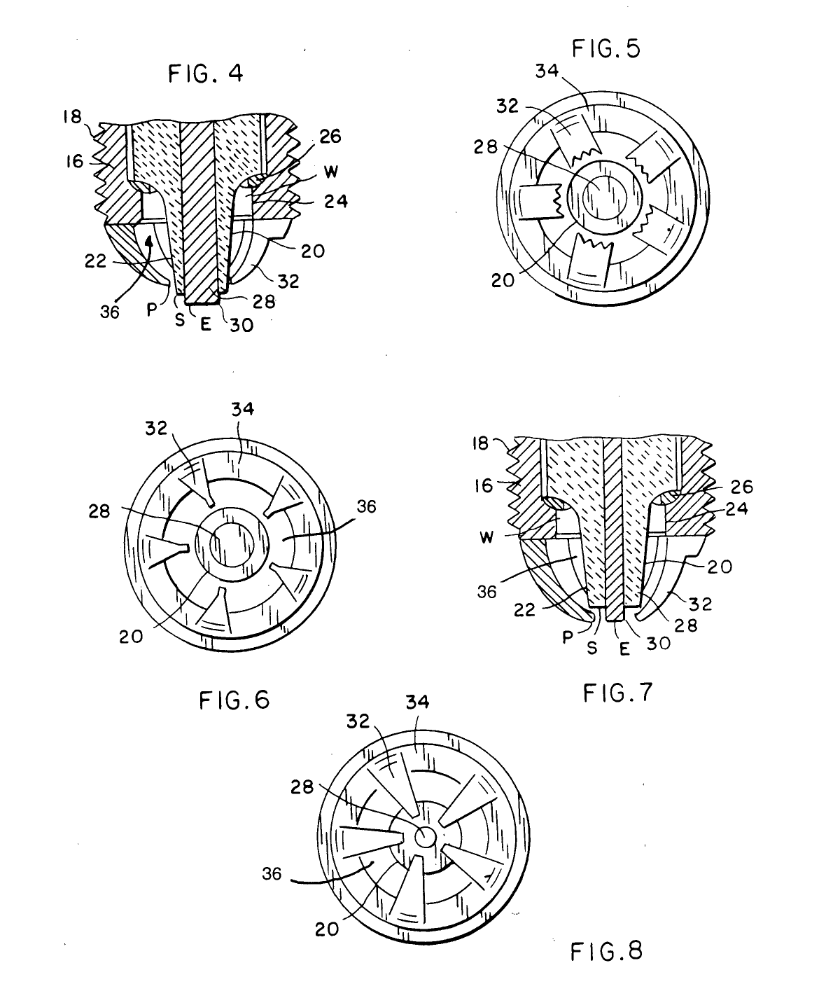

The insulator 20 may extend from the base 16 to various lengths. The tapered portion may end approximately in alignment with as the ends of the ground prongs 32 as illustrated in FIG. 3, be longer and extend beyond the ground prong ends 32 as illustrated in FIG. 4, or be shorter and not extend to the ends P of the ground prongs 32 as illustrated in FIG. 7. The length of the insulator 20 is dependent on the intended use of the spark plug 10. Spark plugs 10 having shorter insulators 20 generally run cooler and those with longer insulators 20 run hotter. The type of engine and the use, whether it be marine, heavy industrial, sports car, etc., determine this configuration. It is to be noted that the center electrode 28 preferably extends beyond the ground prongs 32 as this has been found to insure the most satisfactory conduction of the spark and aid in the creation of the surface to air gap spark travel as will be discussed further. The ends P of the ground prongs 32 may also extend over the planar surface of the nose core 22, as illustrated in FIGS. 7 and 8, in certain engines. Such is the case with diesel spark assisted combustion or very high compression engines. The increased combustion chamber pressures of these engines require small spark gaps as increased pressure increases electrical resistance of the system. By moving the ends P of the ground prongs 32 over the insulator, the air gap between the insulator 20 and the ground prong 32 is lessened and the spark can overcome the resistance and cross the gap.

The exterior portion of the insulator core nose 22 that is located closest to the end of the ground prong P is referred to within this description as S. It is to be understood that S surrounds the insulator 20 near the ground prong end P so as to generally form a circle. The distance between S and P is defined in this description as A, which is the air gap between the two. The point where the insulator 20 connects to the base 16 and begins to form the inner side wall 24 is referred to in this description as W. A circumferential surface ring of the central electrode tip 30 is referred to in this description as E.

Foreign material deposits on the insulator 20 normally takes place during starting and idling modes of the engine. If any foreign material deposits on the core nose 22 or insulator 20 surface, these deposits will probably be in some form of carbon or oil. Since carbon is electrically conductive, it would be the path of least resistance. Therefore, if any foreign material collects on the insulator 20, the spark will have a tendency to follow the path of least resistance and ionize and remove the deposit immediately.

In constructing the spark plug 10, the ground prongs 32, central electrode 28, and insulator core nose 22 are positioned relative one another and constructed of materials which encourage a surface to air gap spark path. The actual spaced relations of these components may vary depending on several factors including available voltage, compression ratios, cylinder pressures, engine revolutions per minute and the intended use of the spark plug 10. Thus, the electrical resistance of the distance P to E is to be greater than the electrical resistance of E to S to A to P. Likewise, the electrical resistance of the distance E to S to W is greater than the electrical resistance of E to S to A to P. Therefore, when a spark is generated at the central electrode tip 30, it travels from E to the core nose or even insulator surface S before jumping the air gap A to the end of ground prong P. If there is a deposit further up the insulator 20, the spark will travel to that point S and ionize and remove the deposit before jumping the air gap A to the closest ground prong end P. Therefore, any deposits which form on either the insulator 20, central electrode 28 or ground prong 32 are removed while the spark plug 10 is in operation.

The inner side wall 24 and ground prongs 32 form a fire hole 36. Plating of the fire hole 36 with a material such as platinum forms a reactive chamber that creates a plasma of fuel and air which in turn increases burn efficiency.

The plated area of the fire hole 36 could be knurled to increase its surface area. Longitudinal ribs of a plain or convoluted nature, as well as circumferential ribs of fins could also be used to increase the surface area of the fire hole 36.

It is to be noted that if one could observe the firing of the spark plug 10 using multiple ground prongs 32 over time, that there would be a mass of the various spark paths in all different directions to the ground prongs 32. This is due to the multiple spark presentations provided by the spark travel path and use of multiple ground prongs 32 as opposed to a single ground prong.

Surface to air gap spark plugs have been provided the Inventor in the past, such as the spark plug of U.S. Pat. No. 5,633,557. The present invention offers the same advantages of these surface to air gap spark plugs; increased heat resistance, increased fuel efficiency, additional horsepower and torque and anti-fouling properties. However, the incorporation and placement of the multiple ground prongs 32 achieves added benefits. The spark plug of the '577 patent requires a high voltage to fire and does not operate optimally with the newer ignition systems. However, the spark plug 10 of the present invention requires much less voltage energy to fire and is well adapted for the newer ignition systems.

Another added benefit of the spark plug of the present invention is that its voltage requirements do not increase linearly with increased combustion chamber pressures. Typically, a spark plug requires a proportional increase in voltage to fire when there is an increase in combustion chamber pressure. This relationship is sometimes referred to as a “K” value as an increase in thousands of volts or kilovolts are needed to overcome these increased pressures. This relationship is typically linear. The spark plug 10 of the present invention has been found to not have a linear “K” value in test pressure chambers. The increased voltage requirements do not match increased combustion chamber pressures. Instead, the required voltage levels off and remains in a near static state as the combustion chamber pressure increases. Thus, increased pressures may be used without the anticipated increased voltage supply requirements.

Although several embodiments have been described in detail for purposes of illustration, various modifications may be made without departing from the scope and spirit of the invention. Accordingly, the invention is not to be limited, except as by the appended claims.

1. A spark plug, comprising:
an elongated tubular housing having a central longitudinal axis and forming an inner chamber therein, the housing including a terminal at one end thereof and a base having an internal side wall at an opposite end, wherein a portion of the internal side wall comprises platinum-plating;
at least one ground prong extending from the base and towards the central longitudinal axis of the housing to an end referred to as P;
an insulator mounted within the inner chamber of the housing, having at least a portion which extends from the base, at a point referred to as W, along the central longitudinal axis and tapers to a core nose, a circular portion of which that is closest to P referred to as S, resulting in an air space formed between S and P referred to as A; and
an electrode embedded within the insulator, a tip of which protrudes from the insulator, the electrode having an exterior ring thereof which is closest to P referred to as E, P being closer to E than to W, P to E forming an electrical path which is different than the electrical path from E to S to A to P, the electrical resistance of P to E being greater than the electrical resistance of E to S to A to P, and the electrical resistance from E to S to W being greater than the electrical resistance of E to S to A to P, whereby a generated spark travels from E of the electrode to S of the insulator across air gap A to P of the ground electrode, and wherein the platinum plating of the internal side wall forms a reactive chamber that creates a plasma of fuel and air when the spark ignites the fuel.

2. The spark plug of claim 1, wherein the insulator extends beyond the at least one ground prong.

3. The spark plug of claim 1, wherein the at least one ground prong extends beyond the insulator.

4. The spark plug of claim 1, wherein the at least one ground prong and a terminal end of the insulator are aligned.

5. The spark plug of claim 1, including a ground ring connected to the base from which the at least one ground prong extends.

6. The spark plug of claim 1, wherein the at least one ground prong has sharp edges.

7. The spark plug of claim 1, wherein multiple ground prongs extend from the base.

8. The spark plug of claim 1, wherein the portion of the insulator extending from the base is substantially frustroconical in shape.

9. The spark plug of claim 1, wherein the spark travel is such so as to clean the insulator of surface deposits.

10. A spark plug, comprising:
an elongated tubular housing having a central longitudinal axis and forming an inner chamber therein, the housing including a terminal at one end thereof and a base having an internal side wall at an opposite end, wherein a portion of the internal side wall comprises platinum-plating;
a ground ring connected to the base and having multiple prongs each extending therefrom and towards the central longitudinal axis of the housing to an end referred to as P;
an insulator mounted within the inner chamber of the housing, having at least a portion which extends from the base, at a point referred to as W, along the central longitudinal axis and tapers to a core nose, a circular portion of which that is closest to P referred to as S, resulting in an air space formed between S and P referred to as A; and
an electrode embedded within the insulator, a tip of which protrudes from the insulator, the electrode having an exterior ring thereof which is closest to P referred to as E, P being closer to E than to W, P to E forming an electrical path which is different than the electrical path from E to S to A to P, the electrical resistance of P to E being greater than the electrical resistance of E to S to A to P, and the electrical resistance from E to S to W being greater than the electrical resistance of E to S to A to P, whereby a generated spark travels from E of the electrode to S of the insulator across air gap A to P of the ground electrode and the spark travel is such so as to clean the insulator of surface deposits, and wherein the platinum plating of the internal side wall forms a reactive chamber that creates a plasma of fuel and air when the spark ignites the fuel.

11. The spark plug of claim 10, wherein the insulator extends beyond the at least one ground prong.

12. The spark plug of claim 10, wherein the at least one ground prong extends beyond the insulator.

13. The spark plug of claim 10, wherein the at least one ground prong and a terminal end of the insulator are aligned.

14. The spark plug of claim 10, wherein the ground prongs have sharp edges.

15. The spark plug of claim 10, wherein the portion of the insulator extending from the base is substantially frustroconical in shape.

16. A spark plug, comprising:
an elongated tubular housing having a central longitudinal axis and forming an inner chamber therein, the housing including a terminal at one end thereof and a base having an internal side wall at an opposite end, wherein a portion of the internal side wall comprises platinum-plating;
a ground ring connected to the base and having multiple prongs each extending therefrom and towards the central longitudinal axis of the housing to an end referred to as P having sharp edges;
an insulator mounted within the inner chamber of the housing, having at least a portion which extends from the base, at a point referred to as W, along the central longitudinal axis and tapers in a frustroconical shape to a core nose, a circular portion of which that is closest to P referred to as S, resulting in an air space formed between S and P referred to as A; and
an electrode embedded within the insulator, a tip of which protrudes from the insulator, the electrode having an exterior ring thereof which is closest to P referred to as E, P being closer to E than to W, P to E forming an electrical path which is different than the electrical path from E to S to A to P, the electrical resistance of P to E being greater than the electrical resistance of E to S to A to P, and the electrical resistance from E to S to W being greater than the electrical resistance of E to S to A to P, whereby a generated spark travels from E of the electrode to S of the insulator across air gap A to P of the ground electrode, the spark travel is such so as to clean the insulator of surface deposits, and the energy requirements for the spark plug do not increase linearly with increased combustion chamber pressure, and wherein the platinum plating of the internal side wall forms a reactive chamber that creates a plasma of fuel and air when the spark ignites the fuel.

17. The spark plug of claim 16, wherein the insulator extends beyond the at least one ground prong.

18. The spark plug of claim 16, wherein the at least one ground prong extends beyond the insulator.

19. The spark plug of claim 16, wherein the at least one ground prong and a terminal end of the insulator are aligned.
